(19) United States
(12) Patent Application Publication
(10) Pub. No.: US 2005/0228713 A1
(43) Pub. Date: Oct. 13, 2005

(54) Customer value chain business analysis

(76) Inventors: John C. Manzolillo, Baltimore, MD (US); Gregory Matthew Whiteman, (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/952,175

(22) Filed: Sep. 29, 2004

Related U.S. Application Data
(60) Provisional application No. 60/561,159, filed on Apr. 9, 2004.

(51) Int. Cl. G06F 17/60

(52) U.S. Cl. 705/10

(57) ABSTRACT

A system and method for analyzing a relationship with a business target according to the business target's customer value chain. The customer value chain includes the links of customer acquisition, customer fulfillment, and customer retention. A business target is identified, and a decision maker within the business target for each link of the business target's customer value chain is identified. Each identified decision maker is interviewed according to a template. The template is stored on a processing system and reflects an interview outline including each link of the business target's customer value chain. The data from the interview is entered into the processing system through the template. The template provides a user interface with the data processing system. A relational database stores and organizes the data, and a processor analyzes the data stored in the relational database using the processor.

The present application claims priority to U.S. Provisional Patent Application No. 60/561,159, filed on Apr. 9, 2004, in the names of John C. Manzolillo and Gregory Matthew Whiteman titled Customer Value Chain Business Analysis the contents of which are expressly incorporated herein by reference.

### BACKGROUND OF THE INVENTION

A. Field of the Invention

The present invention relates to systems and methods for analyzing a relationship with a business target, and in particular analyzing the relationship with a business target according to the business target's customer value chain.

B. Description of the Related Art

Surveys and polls aid marketing decisions and provide resource allocation guidance. Many companies rely on industry specific surveys. In addition, companies may track customer contacts and collect customer information. Available software programs collect such information and automate, for example, customer contact tracking.

A customer value chain represents the cycle of events or activities that a business plans, executes, measures, evaluates and adapts in order to execute its business strategy and tactics towards achieving its business goals and objectives. The primary links in the value chain may include acquiring customers, fulfilling goods and or services to those customers, retaining and growing those customers' business, and communicating with those customers and other stakeholders, including employees, suppliers and investors.

### SUMMARY OF THE INVENTION

This invention relates to systems and methods for analyzing a relationship with a business target according to the business target's customer value chain.

Embodiments of the invention provide a customer value chain business analysis, a business analysis methodology and processes used by a company to identify and analyze its share of business with its customers relative to its competition. Another objective of the invention includes an analysis of the communication of information and distribution of materials processes. Objectives of the invention include assessing and prioritizing opportunities to improve these processes.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

To achieve the objects and in accordance with the purpose of the invention, as embodied and broadly described herein, an embodiment of the invention comprises systems and methods for analyzing a relationship with a business target according to the business target's customer value chain, the customer value chain comprising the steps of customer acquisition, customer fulfillment, and customer retention. The method for analyzing comprises the steps of: identifying a business target; identifying a decision maker within the business target for each step of the business target's customer value chain; interviewing each identified decision maker according to a template stored on a processing system, the template comprising an interview outline including each step of the business target's customer value chain; entering data from the interview into the processing system, the template providing a user interface with the data processing system; storing the data in a relational database; and analyzing the data stored in the relational database using the processor.

Another embodiment of the invention comprises a method, executed by a processor, for analyzing a relationship with a business target according to the business target's customer value chain, the customer value chain comprising the links of customer acquisition, customer fulfillment, and customer retention. The method for analyzing comprising the steps of: receiving data through a template, the data originating from a decision maker within the target for each link of the target's customer value chain, the template comprising an interview outline including each link of the business target's customer value chain; storing the data in a relational database; and analyzing the data stored in the relational database.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a schematic diagram of a processing system according to one embodiment.

FIG. 2 is a flow chart of a process for analyzing a relationship with a business target according to the business target's customer value chain using a processor.

FIG. 3 is a flow chart of a process executed within a processor for analyzing a relationship with a business target according to the business target's customer value chain.

FIG. 4 is a diagram of an example customer value chain for a business target of the U.S. Postal Service.

FIGS. 5, 6, and 7 show lines 1-132 of an example template from the U.S. Postal Service embodied in a Microsoft Excel file. The entire template can be found in U.S. Provisional Patent Application No. 60/561,159, filed on Apr. 9, 2004, the contents of which are expressly incorporated herein by reference.

FIG. 8 shows an example analysis report for a hypothetical business target of the U.S. Postal Service.

### DESCRIPTION OF THE PREFERRED EMBODIMENTS

Reference will now be made in detail to the present preferred embodiments of the invention, examples of which are illustrated in the accompanying drawings. Wherever possible, the same reference numbers will be used throughout the drawings to refer to the same or like parts.

According to one embodiment, a relationship with a business target is analyzed according to the business target's customer value chain. The business target may be a current client or customer, a future client or customer, a former client or customer, or a potential client or customer. The customer value chain includes the links of customer acquisition, customer fulfillment, and customer retention. Data is gathered from a decision maker at the business target focusing specifically on each link of the customer value chain. The data is then entered into a processing system and analyzed in view of the customer value chain. A relational database within the processing system may store and organize the data.

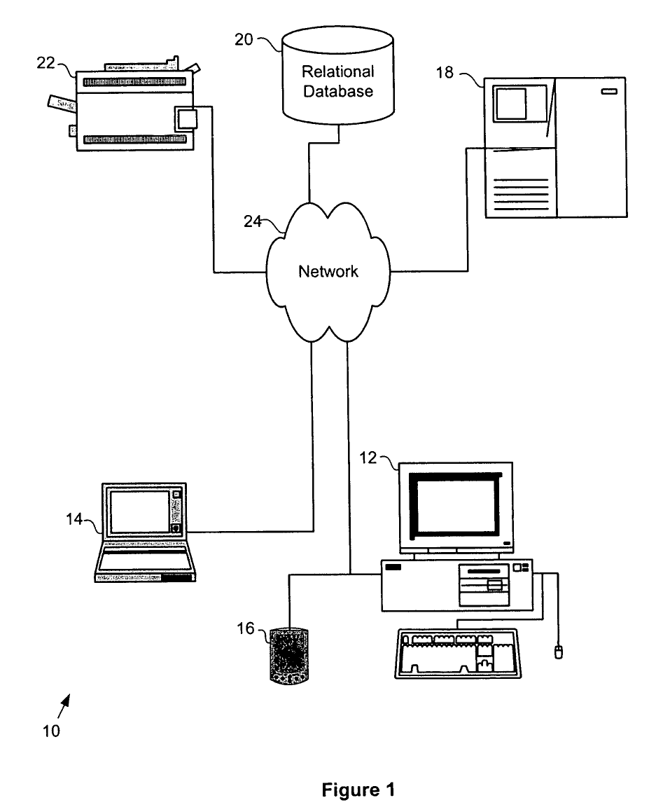

FIG. 1 shows a schematic diagram of a system 10 for analyzing a relationship with a business target. After conducting an interview or during an interview, answers may be entered, for example, through a personal computer 12, a laptop computer 14, or a handheld computer 16. The handheld computer 16 may be used during an interview at the location of the business target and may connect to the personal computer 12 or may connect directly to a server 18 through a network 24 after the interview. Software templates, such as a Microsoft Excel file or some other spreadsheet file, loaded on the personal computer 12, the laptop computer 14, or the handheld computer 16 may direct, organize, and aid this data entry. The template reflects the relevant customer value chain for the particular business target.

Data reaches the server 18 through the network 24, and the server 18 may store the data in a relational database 20. If the template is a standalone file, such as a spreadsheet, the template can be sent to the server 18 as an electronic mail attachment. The use of electronic mail allows remote computing and the use of the Internet. Alternatively, the data may be entered directly into the server 18 and the relational database. With direct entry, the template may not be a standalone file, but may be a direct interface to the relational database 20. The relational database 20 stores and organizes the data for processing by the server 18. The system 10, in for example the server 18 or the personal computer 12, analyzes the data in view of the relevant customer value chain. A screen of the personal computer 12, the laptop computer 14, or the handheld computer 16 may display analytical results, and a printer 22 may print out a report of the analytical results.

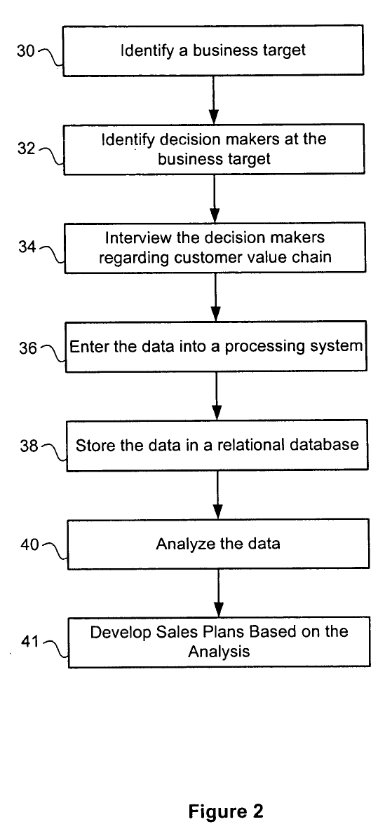

FIG. 2 is a flow chart of a process for analyzing a relationship with a business target according to the business target's customer value chain using a processor. A business target is identified in step 30, and decision makers within the business target for each link of the customer value chain are identified in step 32. Those decision makers are interviewed regarding the business target's customer value chain in step 34. The interview preferably includes open ended and closed ended questions and seeks both subjective and objective information regarding the business target's customer value chain.

During or after the interview, data from the interview is entered in the processing system 10 at step 34. The order of steps, however, may not be rigid. For example, known or publicly available data regarding the business target could be entered into the processing system 10 prior to the interview at step 34. A processing system 10 stores the data in the relational database 20 initially organized as in the template according to the business target's customer value chain. The relational database 20 stores and organizes the data, and the processor 18 analyzes the data at step 40. Based on that analysis, sales plans are developed at step 41.

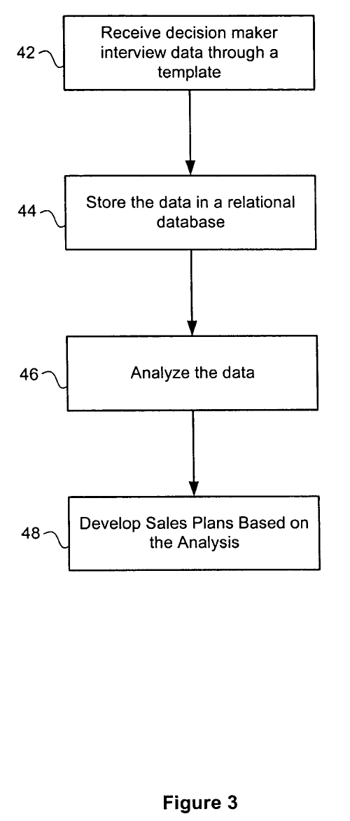

FIG. 3 is a flow chart of a process executed within a processor for analyzing a relationship with a business target according to the business target's customer value chain. The processor receives data from an interview with a decision maker at step 42. The processor receives the data through a software template. The processor stores the data in a relational database in step 44 and analyzes the data in step 46. Optionally, the processor may develop sales plans based on the analysis at step 48.

The invention will be further clarified by the following example from the U.S. Postal Service, which is intended to be purely exemplary of the invention.

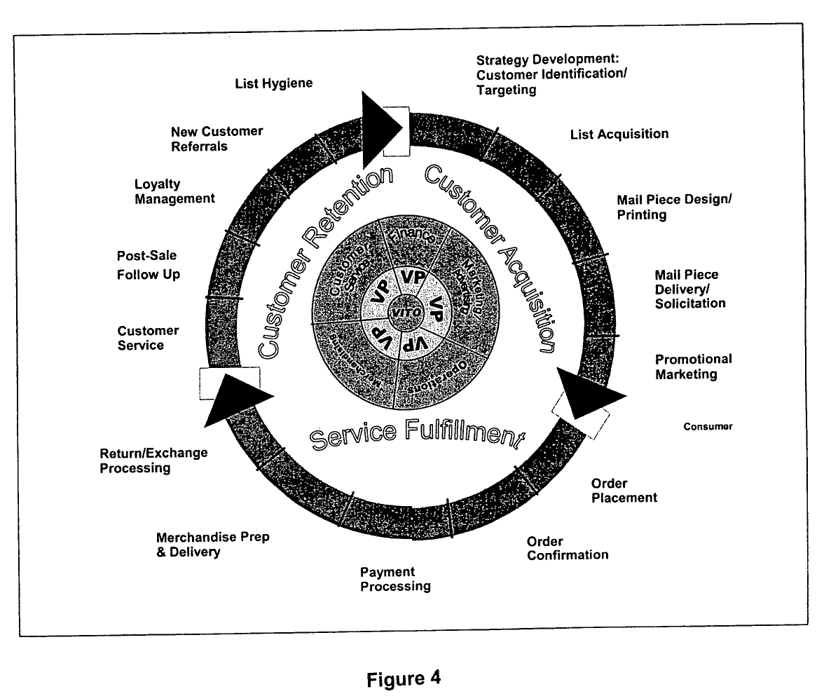

FIG. 4 is a diagram of an example customer value chain for a business target of the U.S. Postal Service. The customer value chain represents the core of customer interaction and service delivery in a typical company. The customer value chain helps businesses identify the tools necessary for maximizing and building customer relationships at every stage. The customer value chain includes everything from promotional marketing to payment processing to loyalty management, grouped together by three business processes: customer acquisition, customer fulfillment, and customer retention.

Each link of the customer value chain includes sub-links. In this example, the customer acquisition link includes the sub-links of customer identification and targeting, list acquisition, mail piece design and printing, mail piece delivery and solicitation, and promotional marketing. The service fulfillment link includes the sub-links of order placement, order confirmation, payment processing, merchandise prep and delivery, and return and exchange processing. The customer retention link includes the sub-links of customer service, post-sale follow up, loyalty management, new customer referrals, and list hygiene

A company can analyze its business relationship with a customer to increase the company's market share and raise profitability. A discussion questionnaire or data gathering instrument may start this process. A data input template may be used to enter the information into a processor. A relational database with query and analysis tools stores, organizes, and processes the information. These tools provide a method or process for gathering, analyzing, and interpreting a company's customer's business data.

The discussion questionnaire or data gathering instrument gathers information. The instrument gathers customer data about actions, activities, plans, and the decisions that drive those plans for each segment of the customer value chain. Information may be collected on an annual basis. The instrument may be produced in hard copy to gather information in a face to face interview. That interview may be between a company's sales person or account manager and that person's business account or new business prospect. The questions are designed to identify and record both closed ended and open ended information.

An example data gathering instrument for the U.S. Postal Service is shown in U.S. Provisional Patent Application No. 60/561,159, filed on Apr. 9, 2004, the contents of which are expressly incorporated herein by reference. An example outline of topics found in a data gathering instrument follows:

Introduction Discussion
Company Name
Address
Major Industry Segment
Minor Industry Segment
Business Objective of Decision Maker
Company Mailing Profile—Revenue
Company Mailing Profile—Volume

Customer Acquisition Discussion
Business Concerns
Annual Planning Process
Sales
Customer Acquisition Budget
Customer Acquisition Programs
Customer Acquisition Media (Television, Radio, Newspapers, Mail, etc.)
Type of Mail used for Customer Acquisition

Customer Fulfillment Discussion
Business Concerns
Annual Planning Process
Sales
Customer Fulfillment Budget
Customer Fulfillment Programs
Customer Fulfillment Media
Type of Mail used for Customer Fulfillment

Customer Retention Discussion
Business Concerns
Annual Planning Process
Sales
Customer Retention Budget
Customer Retention Programs
Customer Retention Media
Type of Mail used for Retention Fulfillment

Other Applications Discussion
Employee Communications Programs
Communications Programs for Stockholders
Type of Media Used
Type of Mail Used

The common industry segment value chain as shown in FIG. 4 depicts 15 key functions that drive customer interaction and service delivery in companies. These key functions fall within the three business processes: customer acquisition, customer fulfillment, and customer retention. Each of the business processes and key functions is an interlocking link in the chain. As an example, key functions for the U.S. Postal Service are shown. The key functions could be modified for other industries.

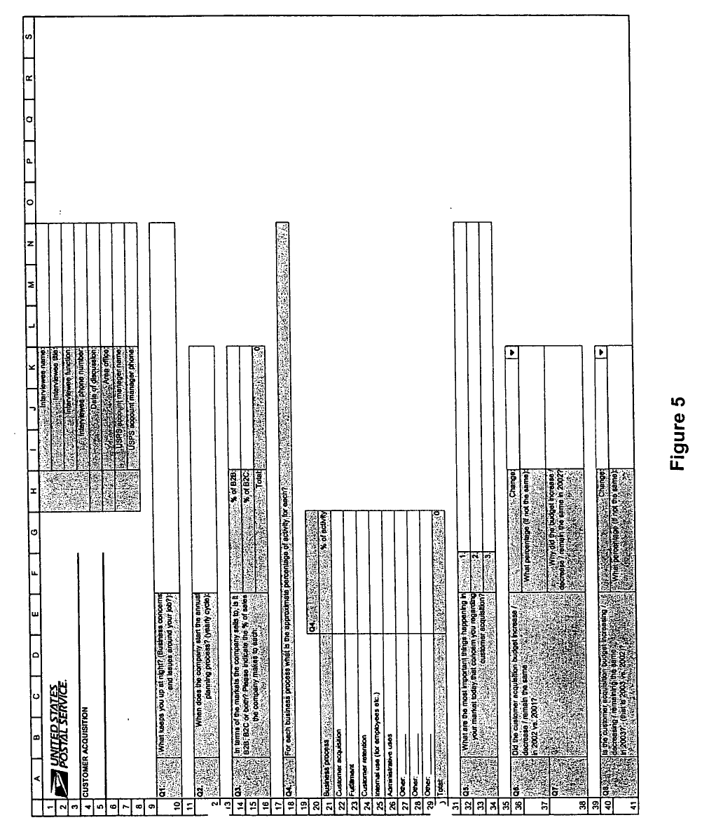

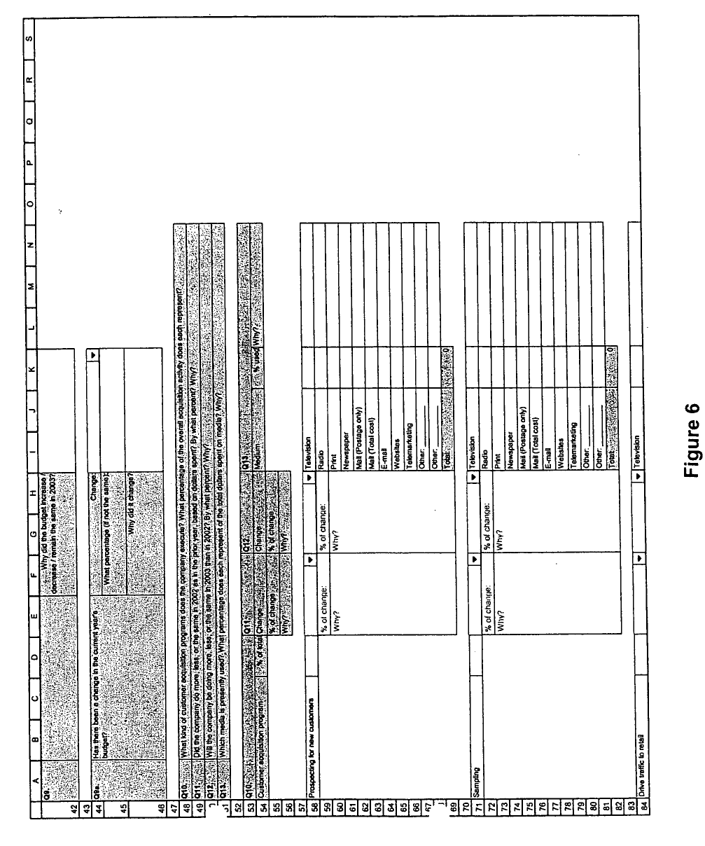

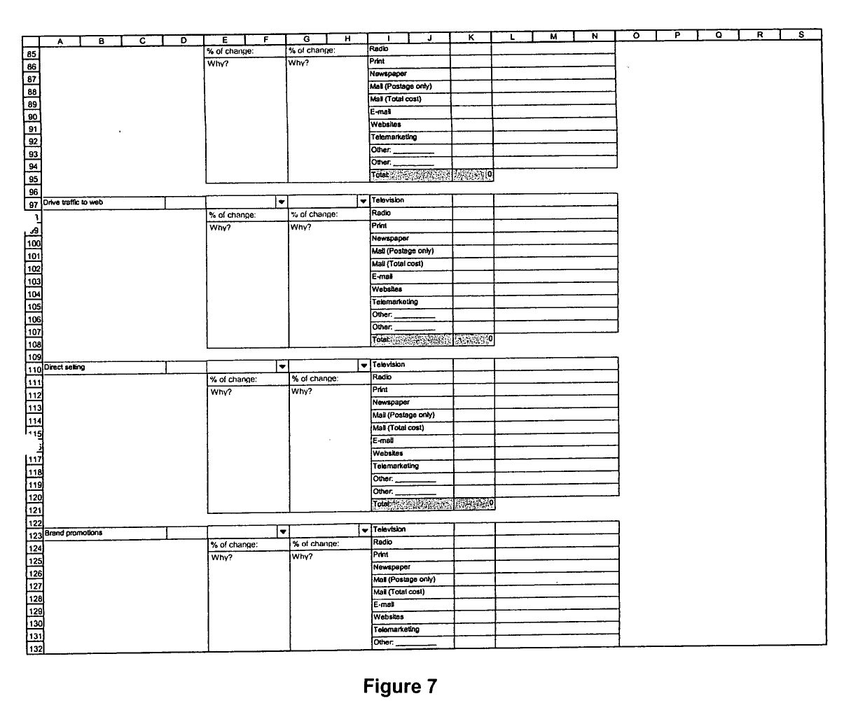

FIGS. 5, 6, and 7 show lines 1-132 of an example template from the U.S. Postal Service embodied in a Microsoft Excel file. The entire template can be found in U.S. Provisional Patent Application No. 60/561,159, filed on Apr. 9, 2004, the contents of which are expressly incorporated herein by reference.

The data input template collects information from the instrument for a processor. The template may be an Excel file, some other spreadsheet program file, or some other software program file. The template may be installed on a laptop computer, a personal computer, or a server. The template accepts data and information gathered in the customer discussion phase. The sales person or account manager enters the data from the data gathering instrument after the interview. The completed template is then sent to a data entry site and loaded into a relational database.

Alternatively, data entry can also be accomplished via data entry screens on a computer (or similar device such as a wireless PDA) or with a web based application that is part of a contact management system. The sales person or account manger could enter the data from the hard copy survey form directly into a computer system, without using the Excel spreadsheet that would then be transmitted to the data entry site.

The relational database may be built in any database application such as IBM DB2, Microsoft Access, or Oracle as well as incorporated into sales management, sales analytics, marketing and CRM systems such as Siebel, or into online applications such as Salesforce.com. In this embodiment, the relational database is preferably built in Microsoft Access.

The database tables are set up to cross tab all closed ended question data for analysis. Reporting allows for both pre-structured output and ad hoc queries.

The gathering, analyzing, and interpreting of a company's customer's business data follows a predetermined sequential process: identify a business customer, account, or prospect to be profiled and analyzed; identify key decision makers for each element of the customer value chain within that account with whom to conduct interview discussions; establish appointments with identified decision makers; conduct discussion interviews to gather data and information; complete data entry; perform data analysis and interpretation; formulate sales strategies and plans based on data analysis and assessment, in line with corporate strategy, goals, and objectives.

The interview process helps identify potential weaknesses in the Customer Acquisition, Fulfillment and Retention links. The interview process also helps identify potential weaknesses in the communication of information and distribution of materials processes as it relates to those links.

The customer value chain approach takes a holistic approach to how companies do business, around their entire value chain or business cycle practices and events for acquiring, fulfilling, retaining, and communicating. The customer value chain uses relational analysis to identify a company's share of its customer's “wallet” versus its competitors and uses modeling to position each company's individual customer's use of its products and services, relative to that customer's “peer group.”

Generated reports can compare data from different business targets. Thus, the customer value chain allows a company to see where that customer or prospect stands relative to other customers or prospects, within a defined industry segment, sub segment, and behavior group, in terms of use of a company's products and services. From this standing or rank, coupled with information gathered on a company's usage trends, the drivers that are affecting their choices of usage and plans to increase or decrease various business activities, a company can determine the value of potential new business from these customers and prospects and prioritize its selling efforts to them.

The report may include an analysis of the communication of information and distribution of materials processes.

For example, this tool can tell a sales person how much the customer is spending on advertising, which is further broken down by the media proportions such as newspaper, direct mail, TV, radio, etc. It will also reveal what proportion of expenditure is with the U.S. Postal Service. It can then be determined depending upon the customer's industry whether the customer is under spending or maximizing his dollars with the U.S. Postal Service. This decision making tool helps the sales people focus their efforts to maximize their business potential with the customer.

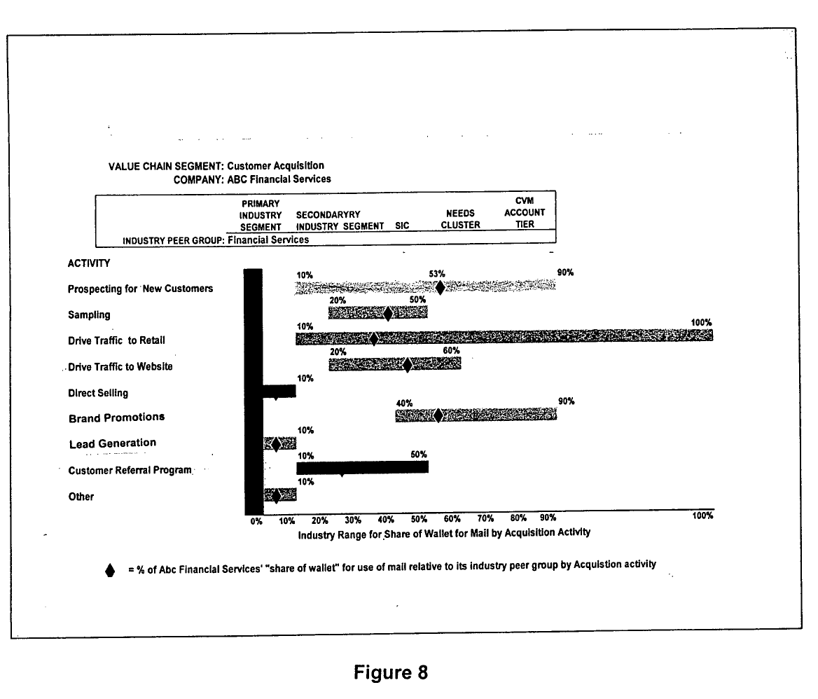

FIG. 8 shows an example analysis report for a hypothetical business target. ABC Financial Services, of the U.S. Postal Service. The left most vertical column list different activities in the customer acquisition link that could involve the U.S. Postal Service. The horizontal bars compare ABC Financial Services' use of the U.S. Postal Service compared to other companies' use of the U.S. Postal Service. In this example, the other companies are in the same industry segment as ABC Financial Services. As shown in FIG. 8, for the activity of prospecting for new customers, the U.S. Postal Service has 53% of ABC Financial Services' business. This compares with an industry segment low of 10% and an industry segment high of 90%.

The business targets may also benefit from the customer value chain analysis. The business target can share there concerns and challenges. The analysis fosters a strategic engagement with the business target and leads to products and services tailored to the business target's needs. At the same time, the analysis establishes long term business relationships.

This process provides a complete methodology including data gathering, analysis, and modeling. This process and system provide a disciplined approach for any commercial company to identify and analyze its business performance with its customers around a value chain model. While the questions are specific to U.S. Postal Service products and services, the concept can be modeled to any business. The relational database structure may be different and specific for each industry.

Embodiments of the present invention have included processors and computer readable media that perform steps in a method for analyzing a relationship with a business target according to the business target's customer value chain. Examples of computer readable media, consistent with embodiments of the invention include hard drives, magnetic disks, optical disks, solid state memory, and web pages, and the programs contained therein. The systems and methods disclosed herein are not related to any particular computer or other apparatus, and may be implemented by any suitable combination of hardware, software, and/or firmware. For example, various general purpose machines may be used with programs written in accordance with teachings of the embodiments of the invention, or it may be more convenient to construct a specialized apparatus or system to perform the required methods and techniques

Embodiments of the invention have been related to program instructions or code for performing various computer-implemented operations based on the methods and processes of the invention. The media and program instructions may be those specifically designed and constructed for the embodiments of the invention, or they may be of the kind well-known and available to those having ordinary skill in the computer software arts. Examples of program instructions include both machine code, such as produced by a computer, and files containing a high level code that can be executed by the computer using an interpreter.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for analyzing a relationship with a business target according to the business target's customer value chain, the customer value chain comprising the links of customer acquisition, customer fulfillment, and customer retention, the method for analyzing comprising the steps of:
identifying a business target;
identifying a decision maker within the business target for each link of the business target's customer value chain;
interviewing each identified decision maker according to a template stored on a processing system, the template comprising an interview outline including each link of the business target's customer value chain;
entering data from the interview into the processing system, the template providing a user interface with the data processing system;
storing the data in a relational database; and
analyzing the data stored in the relational database using the processor.

2. The method of claim 1, wherein the template comprises a computer spreadsheet.

3. The method of claim 1, wherein the template includes open ended and closed ended questions.

4. The method of claim 3, wherein the customer acquisition link includes information related to the business target's advertising budget.

5. The method of claim 3, wherein customer acquisition link includes information related to the type of mail used by the business target.

6. The method of claim 1, wherein the business target is a potential client or customer.

7. The method of claim 1, wherein the business target is a current client of customer.

8. A method, executed by a processor, for analyzing a relationship with a business target according to the business target's customer value chain, the customer value chain comprising the links of customer acquisition, customer fulfillment, and customer retention, the method for analyzing comprising the steps of:
receiving data through a template, the data originating from a decision maker within the target for each link of the target's customer value chain, the template comprising an interview outline including each link of the business target's customer value chain;
storing the data in a relational database; and
analyzing the data stored in the relational database.

9. The method of claim 8, wherein the template comprises a computer spreadsheet.

10. The method of claim 8, wherein the template includes open ended and closed ended questions.

11. The method of claim 10, wherein the customer acquisition link includes information related to the business target's advertising budget.

12. The method of claim 10, wherein customer acquisition link includes information related to the type of mail used by the business target.

13. The method of claim 8, wherein the business target is a potential client or customer.

14. The method of claim 8, wherein the business target is a current client of customer.

15. A system for analyzing a relationship with a business target according to the business target's customer value chain, the customer value chain comprising the links of customer acquisition, customer fulfillment, and customer retention, the system comprising:
means for receiving data through a template, the data originating from a decision maker within the target for each link of the target's customer value chain, the template comprising an interview outline including each link of the business target's customer value chain;
a relational database for storing the data; and
means for analyzing the data stored in the relational database.

16. The system of claim 15, wherein the template comprises a computer spreadsheet.

17. The system of claim 15, wherein the template includes open ended and closed ended questions.

18. The system of claim 17, wherein the customer acquisition link includes information related to the business target's advertising budget.

19. The system of claim 17, wherein customer acquisition link includes information related to the type of mail used by the business target.

20. The system of claim 15, wherein the business target is a potential client or customer.

21. The system of claim 15, wherein the business target is a current client of customer.

22. The system of claim 15, wherein the means for receiving data comprises a personal computer.

23. The system of claim 22, wherein the personal computer comprises a portable computer.

24. The system of claim 22, wherein the computer comprises a handheld computer.

25. The system of claim 24, wherein the handheld computer includes means for wireless communication with the relational database.

26. A computer readable medium having contents for causing a computer-based information handling system to perform steps for analyzing a relationship with a business target according to the business target's customer value chain, the customer value chain comprising the links of customer acquisition, customer fulfillment, and customer retention, the steps comprising:
receiving data through a template, the data originating from a decision maker within the target for each link of the target's customer value chain, the template comprising an interview outline including each link of the business target's customer value chain;
storing the data in a relational database; and
analyzing the data stored in the relational database.
